(19) United States
(12) Patent Application Publication
(10) Pub. No.: US 2021/0101632 A1
(43) Pub. Date: Apr. 8, 2021

(54) OUTBOARD MOTOR MAINTENANCE RACK APPARATUS

(71) Applicant: Jacquline Milan Dolch, Stafford, VA (US)

(72) Inventor: Jacquline Milan Dolch, Stafford, VA (US)

(21) Appl. No.: 17/062,583

(22) Filed: Oct. 3, 2020

Related U.S. Application Data
(60) Provisional application No. 62/910,061, filed on Oct. 3, 2019.

(51) Int. Cl. B62B 1/26; B62B 1/14

(52) U.S. Cl. CPC B62B 1/26; B62B 2202/408; B62B 1/14

(57) ABSTRACT

An outboard motor support and transport system including a support cart having a support frame member with a first side substantially perpendicular to a second side and a third side inclined to the first and second side, a handle member coupled to a first end of the first side of the support frame, a first pivot member coupled to a second end of the first side of the support frame, and a second pivot member formed between the second and third sides of the support frame and a support rack member having a storage cavity with an opening at a first end, wherein the first pivot member of the support cart configured to transport the support cart and the support rack member.

### FIELD OF INVENTION

The present general inventive concept also relates to racks, and more particularly, to a maintenance rack designed to support, transport, and maintain outboard engines, while keeping the outboard motors in operational condition, at all times.

### BACKGROUND

Outboard motors are commonly used for powering small to medium sized boats. These motors are often employed on rapid deployment vessels used in various military and first response applications. As such, these motors need to be transported, maintained, and installed as quick as possible.

There have previously been storage racks designed to store and transport various items, including outboard motors. However, these storage racks often fail to adequately protect the outboard motors from damage during transport and require at least two people to load, unload, and safely move an outboard motor about.

Therefore, what is desired is a maintenance rack apparatus designed to support, transport, and maintain outboard motors using minimal force, while keeping the outboard motors in operational condition, at all times.

### SUMMARY OF THE INVENTION

The present general inventive concept provides a maintenance rack apparatus designed to support, transport, and maintain outboard motors, while keeping the outboard motors in operational condition, at all times.

The present general inventive concept also provides a maintenance rack system which is designed to store, protect, and transport outboard engines.

The present general inventive concept also provides a maintenance rack system designed to store, protect, and transport components of land, air, and sea vehicles.

The present general inventive concept also provides a maintenance rack system which is designed to function as a workbench to aid in the maintenance and repair of outboard motors.

The foregoing and/or other aspects of the present general inventive concept may be achieved by providing an outboard motor support and transport system including a support cart having a support frame member with a first side substantially perpendicular to a second side and a third side inclined to the first and second side, a handle member coupled to a first end of the first side of the support frame, a first pivot member coupled to a second end of the first side of the support frame, and a second pivot member formed between the second and third sides of the support frame, and a support rack member having a storage cavity with an opening at a first end, wherein the first pivot member of the support cart configured to transport the support cart and the support rack member.

The outboard motor support and transport system may include a transcom member coupled between the first and third side supports of the support frame to detachably support to an outboard motor.

The outboard motor support and transport system may include a pivot support member formed between the second pivot member and the third side support of the support frame configured to allow a user to provide weight to support a pivot of the support cart.

The transcom member may be inclined about 14 degrees from the first side support of the support frame.

The handle member may extend in a direction perpendicular to the first side of the support frame.

The foregoing and/or other aspects of the present general inventive concept may be achieved by also providing a support cart including a support frame member having a first side substantially perpendicular to a second side and a third side inclined to the first and second side, a handle member coupled to a first end of the first side of the support frame, a first pivot member coupled to a second end of the first side of the support frame, and a second pivot member formed between the second and third sides of the support frame.

The outboard motor support apparatus may further include a pivot support formed between the second pivot member and the third side support of the support frame.

The outboard motor support apparatus may include a transcom member coupled between the first and third sides of the support frame to detachably support an outboard motor.

The transcom member may be inclined about 14 degrees from the first side support of the support frame.

The handle member may extend in a direction perpendicular to the first side support of the support frame.

Additional aspects of the present general inventive concept will be set forth in part in the description which follows and, in part, will be obvious from the description, or may be learned by practice of the general inventive concept.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view of an outboard motor support and transport system according to an example embodiment of the present general inventive concept:

FIG. 2 is a front view of the outboard motor support and transport system illustrated in FIG. 1:

FIG. 3 is a side view of the outboard motor support and transport system illustrated in FIG. 1;

FIG. 4 is a front perspective view of the outboard motor support and transport system illustrated in FIG. 1, assembled with an outboard motor,

FIG. 5 is a back-perspective view of the outboard motor support and transport system illustrated in FIG. 4;

FIG. 6 is a back view of the outboard motor support and transport system illustrated in FIG. 4;

FIG. 7 is a top view of the outboard motor support and transport system illustrated in FIG. 4:

FIG. 8 is a front perspective view of a support cart of the outboard motor support and transport system according to an example embodiment of the present general inventive concept;

FIG. 9 is a front view of the support cart illustrated in FIG. 8

FIG. 10 is a front perspective view of a support rack of the outboard motor support and transport system according to an example embodiment of the present general inventive concept;

FIG. 11 is a front view of the support rack illustrated in FIG. 10;

FIG. 12A is a side view of a support cart of the outboard motor support and transport system illustrated in FIG. 1 placed adjacent to an outboard motor, in a first position;

FIG. 12B is a side view of the support cart of FIG. 12A in between a first and second position;

FIG. 12C is a side view of the support cart of FIG. 12A in a second position;

FIG. 12D is a side view of the support cart of FIG. 12A partially assembled onto the outboard motor;

FIG. 12E is a side view of the support cart of FIG. 12D completely assembled onto the outboard motor:

FIG. 12F is a side view of the support cart of FIG. 12E and outboard motor pivoted to a position between the first and second positions;

FIG. 12G is a side view of the support cart of FIG. 12F and outboard motor pivoted back to the first position;

FIGS. 13A-13D illustrate a method of assembling the support cart into a support rack of the outboard motor support and transport system, according to an example embodiment of the present general inventive concept;

FIGS. 14A-14C illustrate a method of using the maintenance rack apparatus 100 illustrated in FIG. 9D according to an exemplary embodiment of the present general inventive concept; and

FIGS. 15A-15B are side views of a support cart according to another embodiment of the present general inventive concept.

### DESCRIPTION OF INVENTION

Reference will now be made in detail to the example embodiments of the present general inventive concept, examples of which are illustrated in the accompanying drawings, wherein like reference numerals refer to the like elements throughout. The exemplary embodiments are described below to explain the present general inventive concept by referring to the figures.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Various embodiments of the present general inventive concept provide an outboard engine maintenance rack apparatus, referred to as an outboard engine maintenance rack (“OEMR”) system, which is designed to allow one or two individuals or users to manually move outboard motors quickly and safely in a wide variety of environments. The OEMR system according to the present invention is designed to accommodate outboard engines between 25 horsepower and up to 75 horsepower, however, the present general inventive concept is not limited thereto.

The OEMR system according to the present invention reduces the number of individuals required to safely lift a 55 horsepower multi-fuel outboard motor from four (4) people to one to two (1-2) people. According to MIL-STD 882, DOD Standard for System Safety, for safety purposes the standard requires that at least four individuals are needed to lift the 55 horsepower multi-fuel outboard motor, weighing about 269 lbs. or more.

Conversely, the OEMR system according to the present invention requires only one to two people to safely move the outboard motor by using mechanical advantage of the removable handle member and specifically designed inclined side supports, and without needing to manually lift or pick up the motor.

The OEMR system according to the present invention includes a support frame that is configured and/or designed to allow a single person (i.e., user) to transport, move, install onto/remove from a boat or vessel and maintain the outboard motor supported therein. The single user can use the maintenance rack apparatus to remove an outboard from a boat and move to a storage location. The same maintenance rack apparatus can pivot and rotate, allowing the single user to lay the outboard motor on its side for maintenance or transport.

Further, the outboard motor support and transport system according to the present invention allows the single user to operate (e.g., start) the outboard motor, while the outboard motor is still being supported within the support frame.

The outboard motor support and transport system according to the present invention includes a support frame that designed to be stackable with support frames of other maintenance racks. In an exemplary embodiment, two or more maintenance rack apparatuses may be stacked onto each other for storage and convenience.

The outboard motor support and transport system according to the present invention is specifically designed to protect an outboard motor during transport, installation, and removal, and ensures that the outboard motor is in operational condition, at all times.

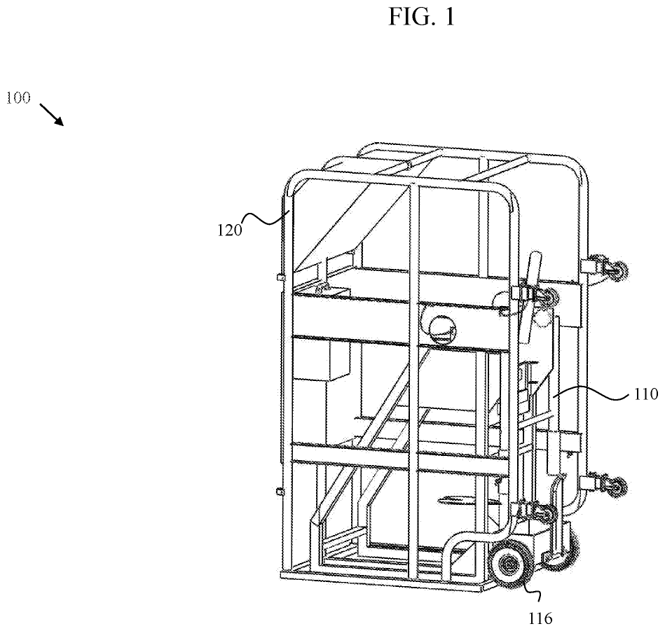

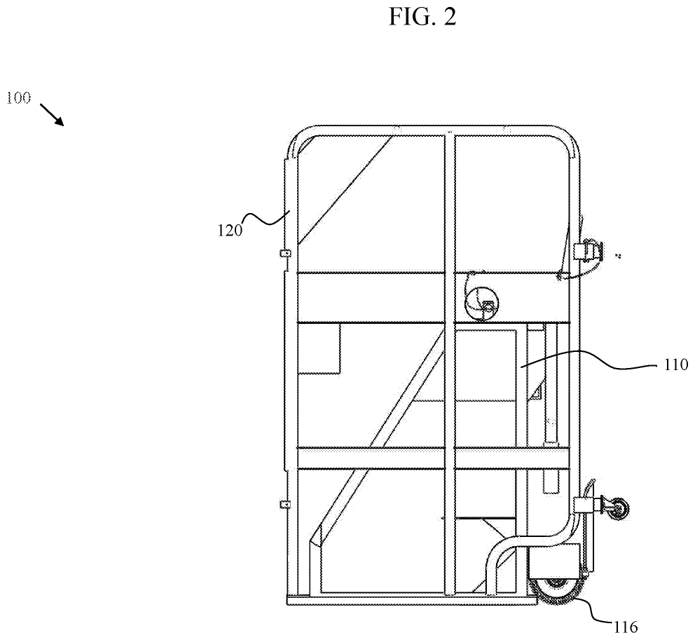

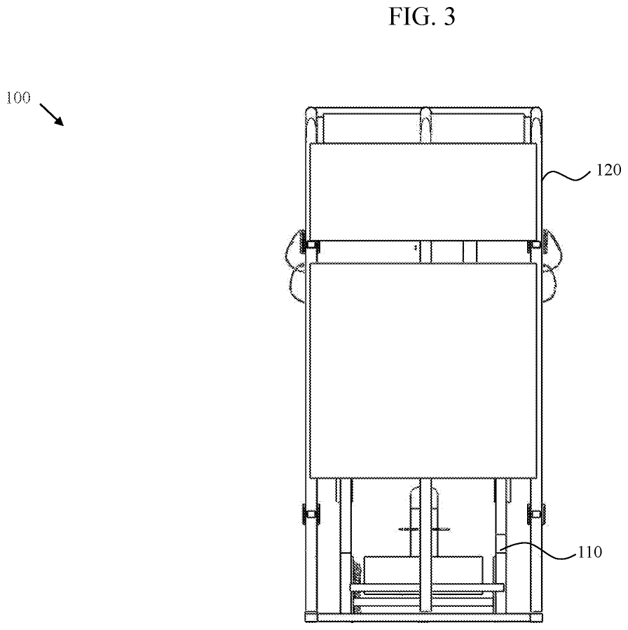

FIG. 1 is a front perspective view of an outboard motor support and transport system 100 according to an example embodiment of the present general inventive concept, FIG. 2 is a front view of the outboard motor support and transport system 100 illustrated in FIG. 1, and FIG. 3 is a side view of the outboard motor support and transport system 100 illustrated in FIG. 1.

Referring to FIGS. 1-3, the outboard motor support and transport system is referred generally herein as 100. The outboard motor support and transport system 100 includes a support cart 110 that is detachably coupled to a support rack member 120 having a storage cavity with an opening at a first end to receive the support cart 110. The outboard motor support and transport system 100 is designed and/or configured to allow a single user to transport, install, and maintain the outboard motor 10 supported by the support cart 110.

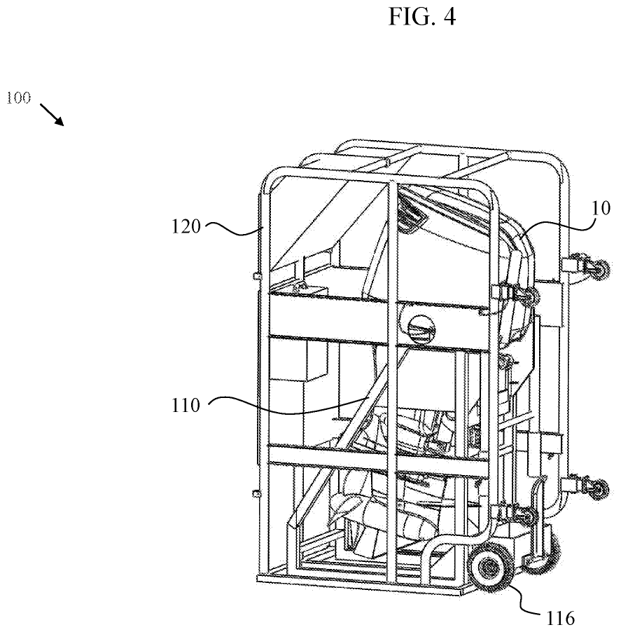

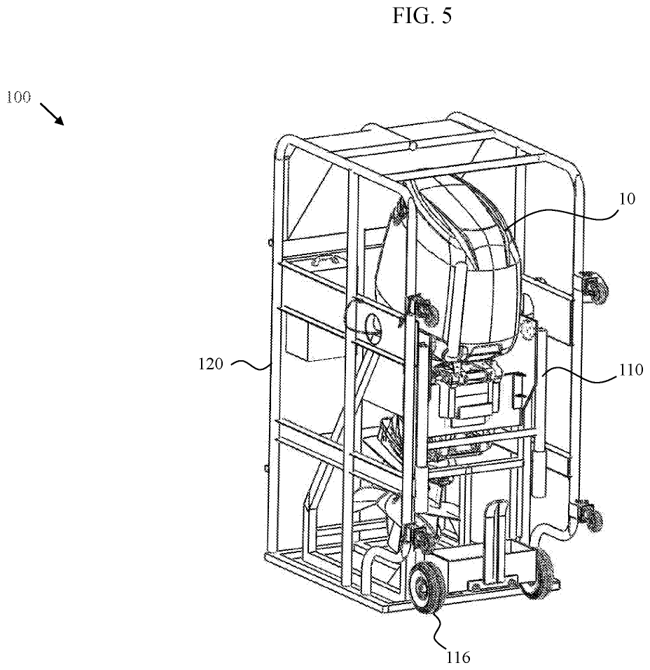

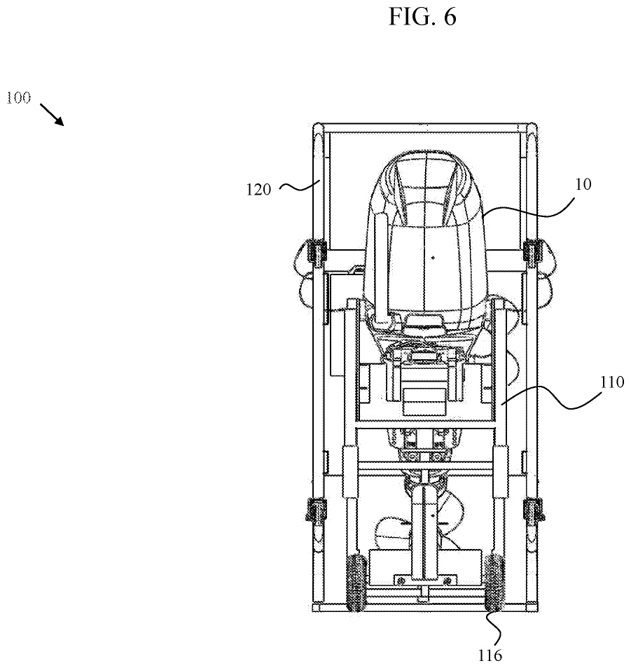

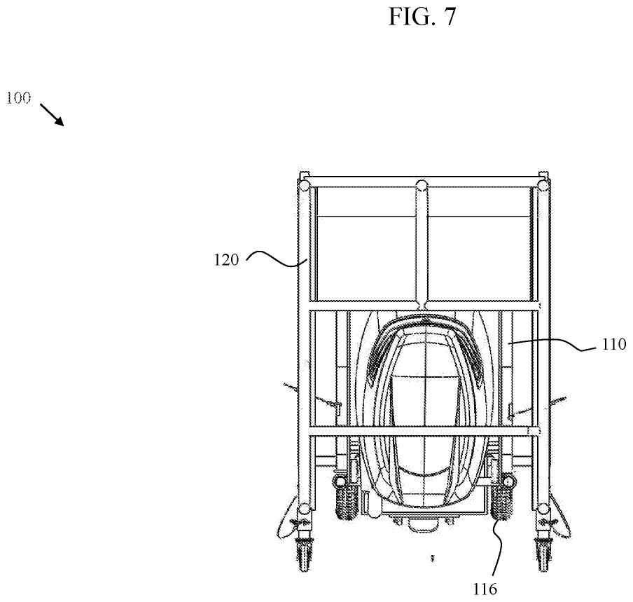

FIG. 4 is a front perspective view of the outboard motor support and transport system 100 illustrated in FIG. 1, assembled with an outboard motor 10, FIG. 5 is a back-perspective view of the outboard motor support and transport system 100 illustrated in FIG. 4, and FIG. 6 is a back view of the outboard motor support and transport system 100 illustrated in FIG. 4. FIG. 7 is a top view of the outboard motor support and transport system 100 illustrated in FIG. 4.

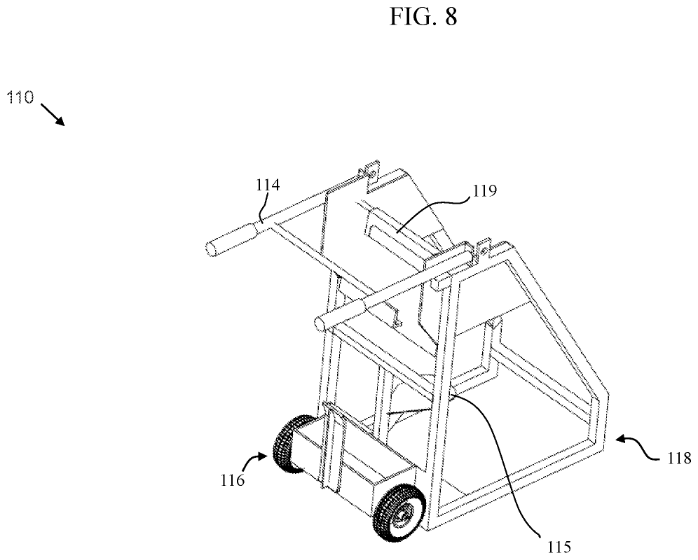

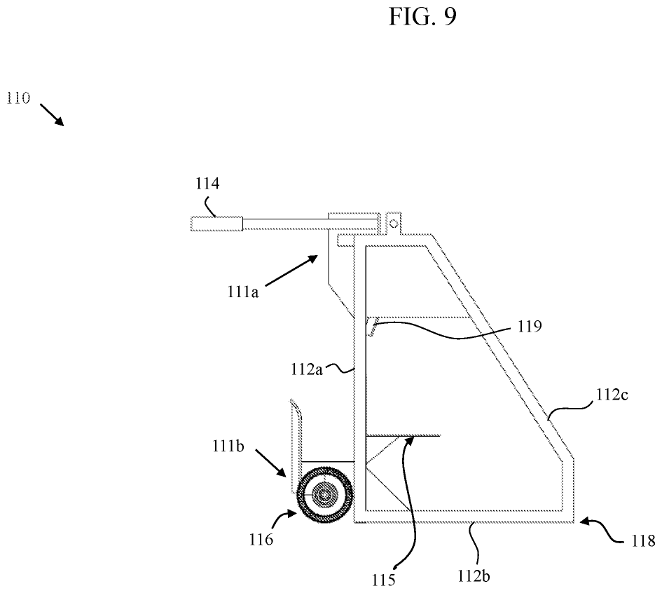

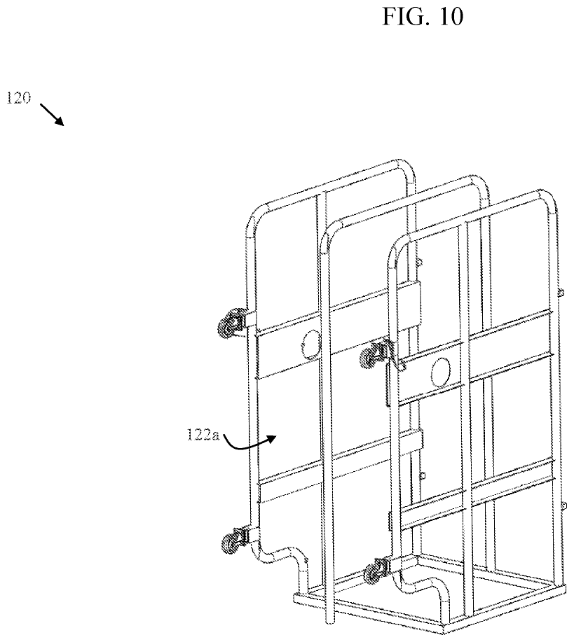

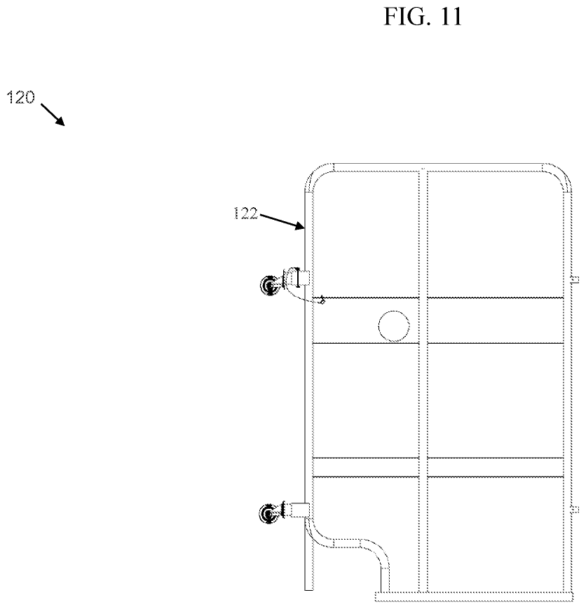

FIG. 8 is a front perspective view of a support cart 110 of the outboard motor support and transport system 100 according to an example embodiment of the present general inventive concept and FIG. 9 is a front view of the support cart 110 illustrated in FIG. 8. FIG. 10 is a front perspective view of a support rack 120 of the outboard motor support and transport system 100 according to an example embodiment of the present general inventive concept and FIG. 11 is a front view of the support rack 120 illustrated in FIG. 10.

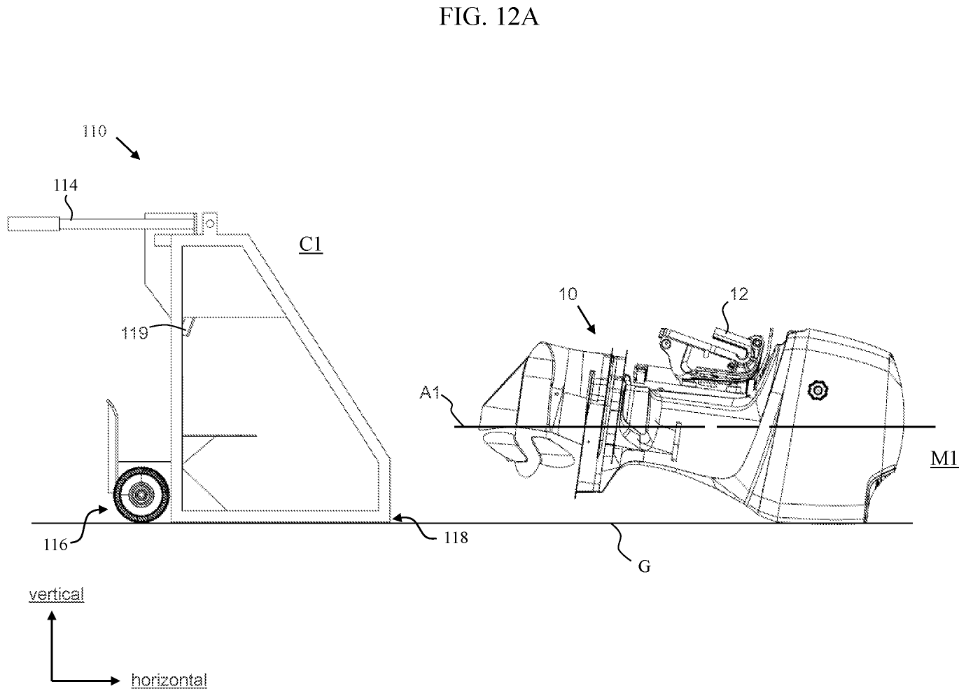

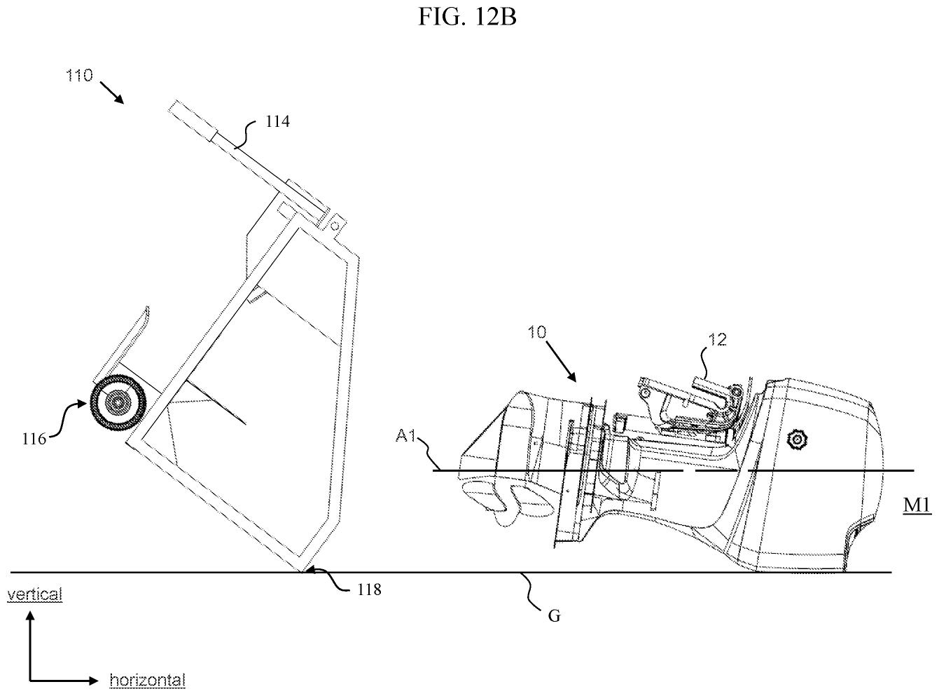

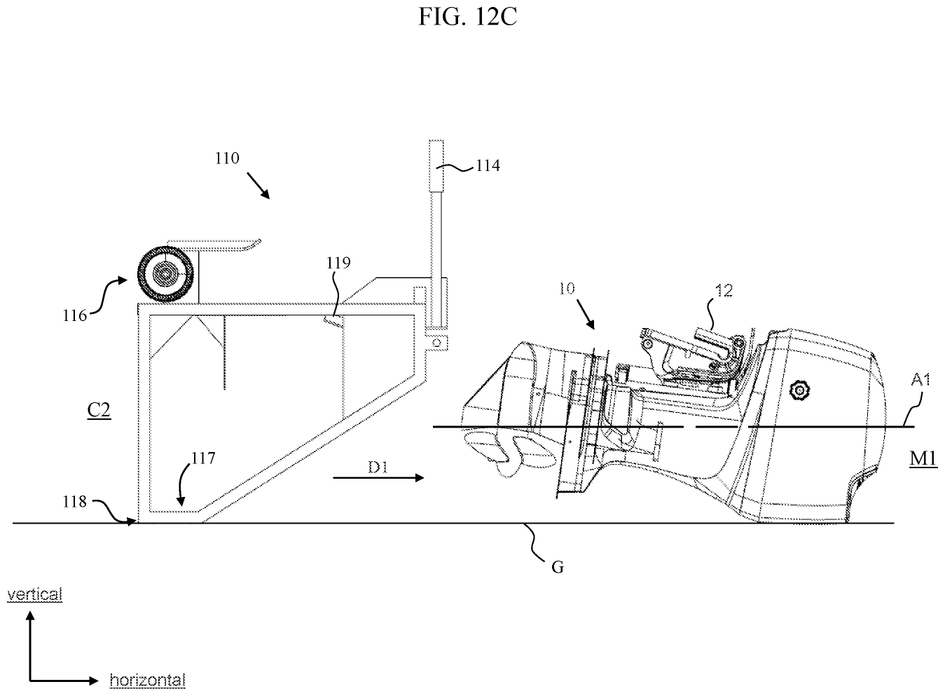

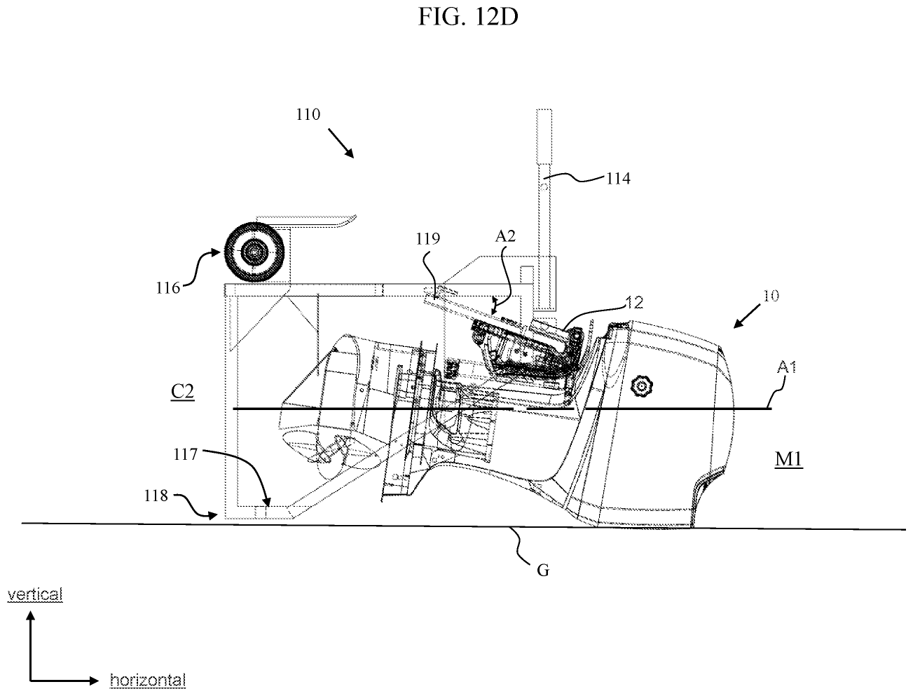

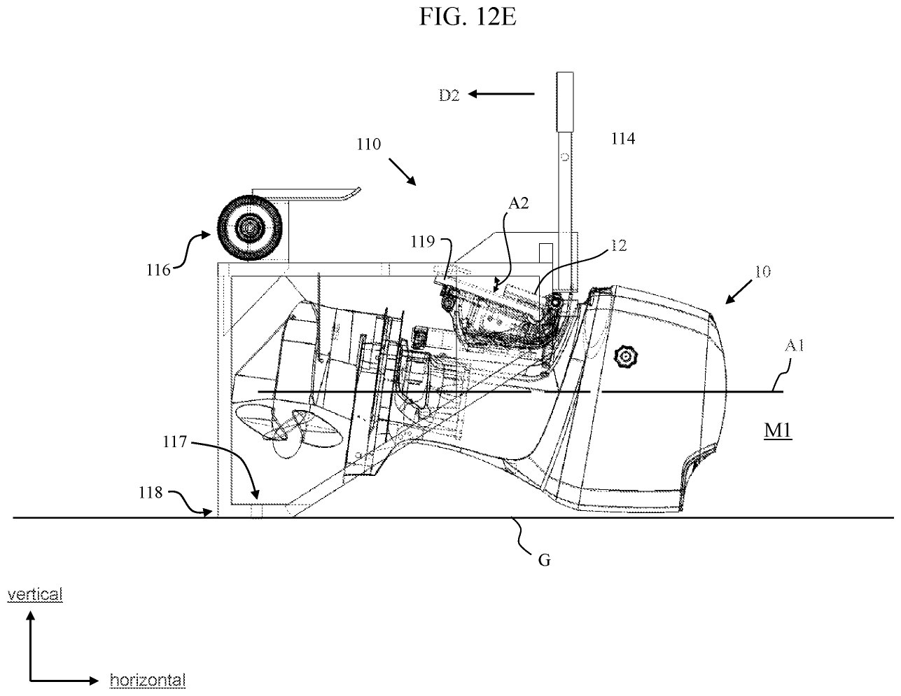

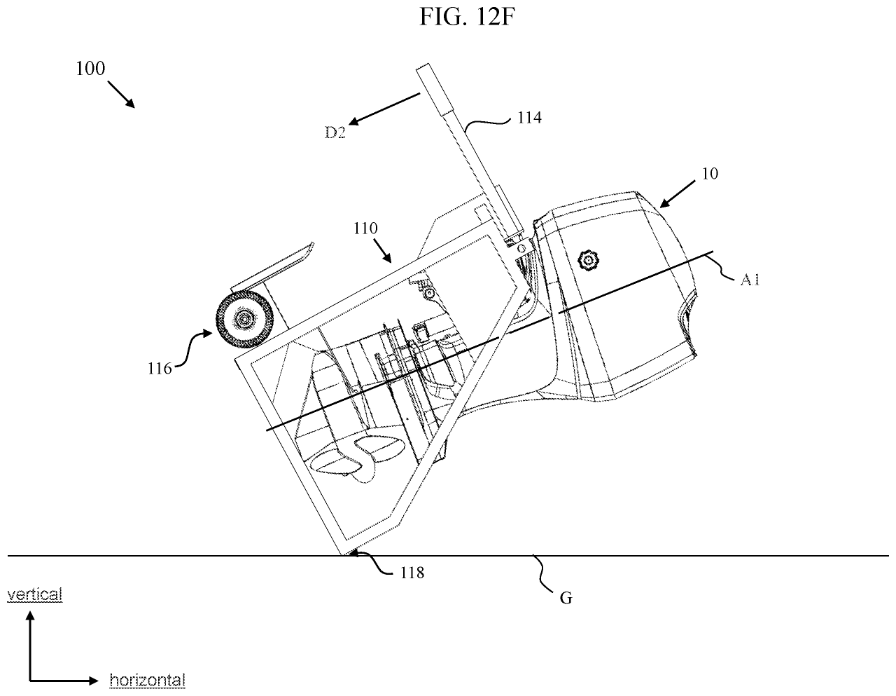

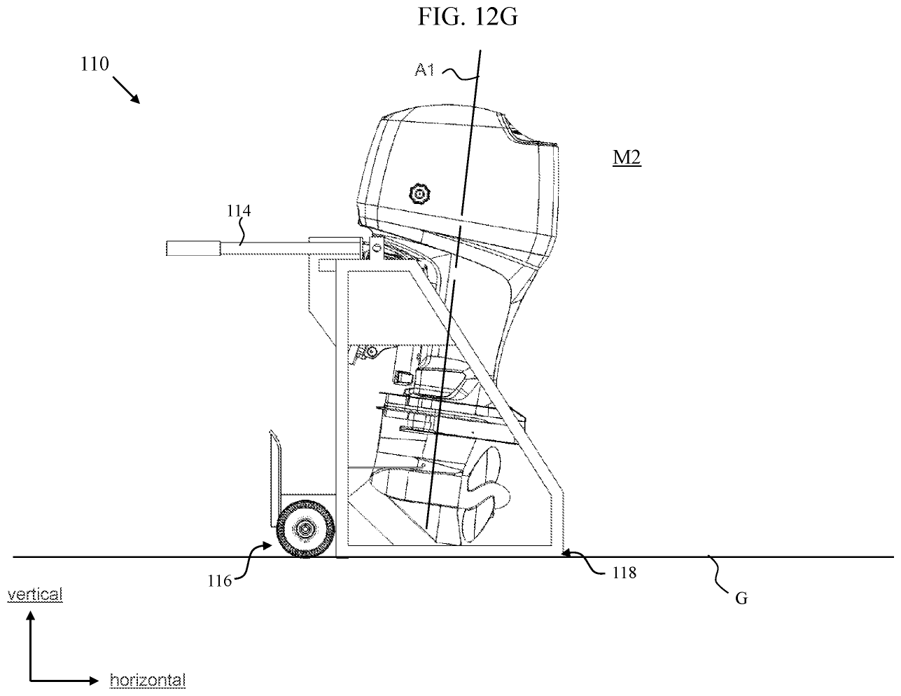

In the present embodiment, the support cart 110 is configured to use leverage to lift an outboard motor 10 from a horizontal position P3 (see FIG. 12A) to a vertical position P4 (see FIG. 12G), using a minimum amount of force. The support cart 110 includes a plurality of supports 112 including a first side support 112a substantially perpendicular to a second side support 112b, and a third side support 112c inclined to the first and second side supports 112a, 112b.

The support cart 110 further includes one or more removable handle members 114 coupled to a first end 11a of the first side support 112a and configured to provide leverage to pivot the support cart 110 from a first position P1 to a second position P2. In the present embodiment, the handle member 114 extends in a direction perpendicular to the first side support 112a of the support frame 110. The removable handle members 114 may be removed to be stowed when not in use and when the support cart 110 is inserted within the support rack 120.

The support cart 110 further includes a first pivot member 116 coupled to a second end 111b of the first side support 112a of the support frame 112 and a second pivot member 118 formed between the second and third side supports 112b, 112c of the support frame 112.

The first pivot member 116 of the support cart 110 is configured to allow a user to pivot the support cart 110 in a vertical direction and transport the support cart 110. The second pivot member 118 of the support cart 110 is configured to allow a user to pivot the support cart 110 between the first position P1 (see FIG. 12A) and the second position P2 (see FIG. 12C).

The support cart 110 further includes a pivot support member 117 formed between the second pivot member 118 and the third side support 112c of the support frame 110 and configured to allow a user to place his/her foot on to provide weight to support pivoting the support cart 110 between the first and second position P1, P2.

In example embodiments, the support cart 110 may be formed as a two-wheeled tubular cart having a transom member 119 across the first end 111a of the first support 112a for mounting an outboard motor 10.

In alternative embodiments, the support cart 110 may be formed with a stabilizer bracket 115 designed to stabilize the outboard motor 10 when running, by preventing or substantially reducing a lower gearcase of the outboard motor 10 from moving side to side.

The stabilizer bracket 115 is located on the support cart 120 and may function as a safety bracket to allow users to run the engine or motor in the support cart 110 during pre-operational and post operational checking by controlling the lower gearcase from moving side to side.

The support cart 110 further includes a transcom member 119 coupled between the first and third side supports 112a, 112c of the support frame 110 to detachably to a mounting bracket 12 12 of a conventional outboard motor 10. In the present embodiment, the transcom member 119 is inclined at an angle A2 about 14 degrees from the first side support 12a of the support frame 110.

In the present embodiment, the support rack member 120 includes a storage cavity 122 formed within a frame member 124 having an opening 122a at a first end configured to receive the support cart 110.

In alternative embodiments, the support rack member 120 may be constructed as a tubular structure formed of metal designed to protect the outboard motor 10 when the support cart 110 is inserted within the support rack 120. The support rack 110 is designed to be lifted by a forklift, a crane, and people.

In alternative embodiments, the support rack member 120 may further include a diagnostic pod configured to attached to the support rack member 120 and provide storage for tools, cables, spare parts, and the like. However, the present general inventive concept is not limited thereto.

In alternative embodiments, the outboard motor support and transport system 100 may further include a diagnostic pod configured to attached to the support rack member 120 and provide storage for tools, cables, spare parts, and the like.

In alternative embodiments, the outboard motor support and transport system 100 may further include an oil pod configured to attached to the support rack member 120 and provide storage for oil for use with the outboard motors 10.

FIG. 12A is a side view of a support cart of the outboard motor support and transport system 100 illustrated in FIG. 1 placed adjacent to an outboard motor 10, in a first position, FIG. 12B is a side view of the support cart of FIG. 12A in a second position, and FIG. 12C is a side view of the support cart 110 of FIG. 12A in a third position.

FIG. 12D is a side view of the support cart 110 of FIG. 12A partially assembled to the outboard motor 10, FIG. 12E is a side view of the support cart 110 of FIG. 12D completely assembled to the outboard motor 10, and FIG. 12F is a side view of the support cart 110 of FIG. 12E and outboard motor 10 pivoted to the second position. FIG. 12G is a side view of the support cart 110 of FIG. 12F and outboard motor 10 pivoted to the first position.

Referring to FIG. 12A, the support cart 110 is positioned in a first position C1 and placed adjacent to an outboard motor 10 having a longitudinal axis A1 in a substantially horizontal position (i.e., first position MI) on the ground G. The outboard motor 10 includes a mounting bracket 12 that is positioned facing an upward (i.e., vertical) direction.

That is, when the outboard motor 10 is placed on the floor or ground G with a back side of the outboard motor 10 being adjacent to the ground G with the tilt or mounting bracket 12 in a raised position, the outboard motor 10 is rotated onto the impeller housing and stood in an upright position.

Next, referring to FIG. 12B, the support cart 110 is lifted in the upward direction using the removable handle member 114 to pivot the support cart 110 from the first position C1 to a second position C2, using the second pivot member 118 pivoting on the ground G.

Next, referring to FIG. 12C, the support cart 110 is at the second position C2 and includes a pivot support member 117 having a straight section that is placed directly on the ground G to stably support the support cart 110 in the second position C2.

Next, referring to FIG. 12D, the support cart 110 includes a transcom 119 that is inserted into the mounting bracket 12 of the outboard motor 10 by sliding the support cart 110 in the horizontal direction (i.e., D1) toward the outboard motor 10.

Next, referring to FIG. 12E, after the transcom 119 is completely inserted into the mounting bracket 12 of the outboard motor 10, conventional attachment members or tilt bracket clamps of the motor 10 is then tightened against a surface of the transcom 119 in order to secure the outboard motor 10 to the support cart 110.

Next, referring to FIG. 12E, a user places his/her foot on top of the pivot support member 117 to prevent the support cart 110 from sliding in a direction away from the outboard motor 10, while the support cart 110 is pivoted from the second position C2 to the first position C1.

Next, referring to FIG. 12F, the user pulls on the removable handle member 114 in the second direction D2, which forces the support cart 110 coupled to the onboard motor 10 to pivot from the first position C1 to the second position C2 using the second pivot member 118 to pivot with the ground G.

Finally, referring to FIG. 12G, the support cart 110 coupled to the onboard motor 10 is at the second position C2, wherein the longitudinal axis A1 of the outboard motor 10 is in a substantially vertical position (i.e., second position MI) on the ground G.

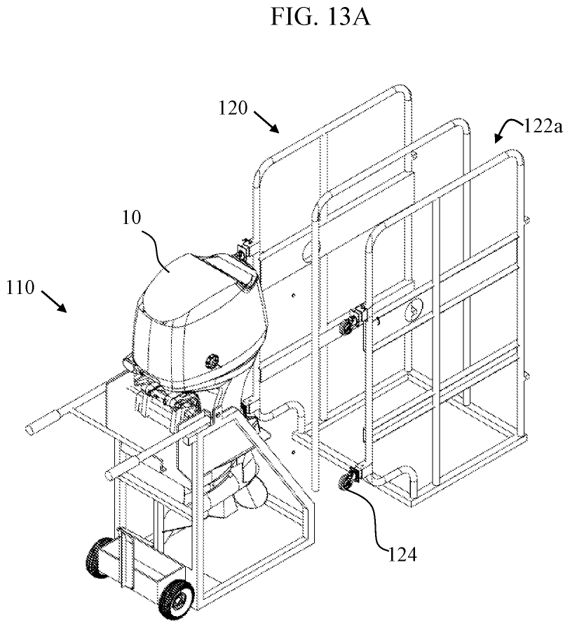

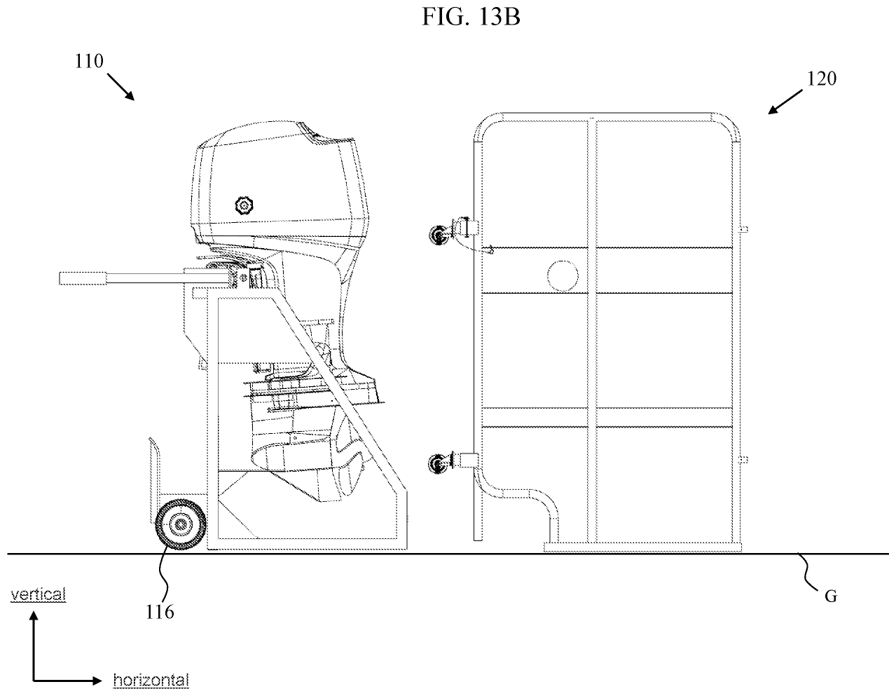

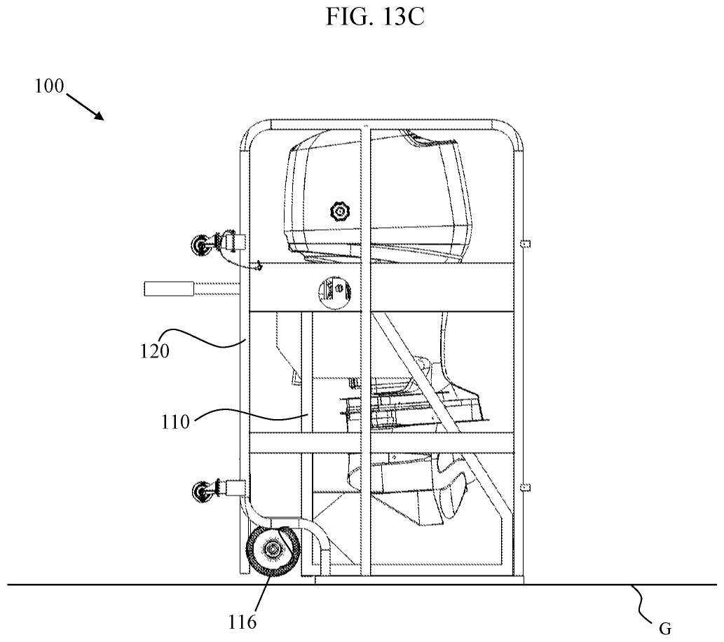

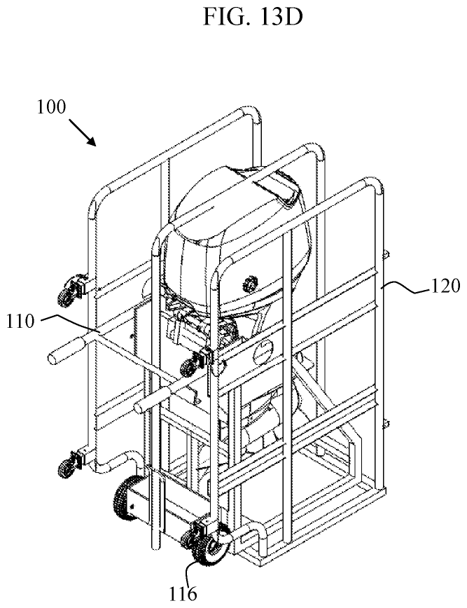

FIGS. 13A-13D illustrate a method 200 of assembling a support cart 110 into a support rack 120 of an outboard motor support and transport system 100, according to an example embodiment of the present general inventive concept.

Referring to FIGS. 13A-13D, the support cart 110 assembled with the outboard motor 10 is installed into a storage cavity 122a of the support rack 120. In the present embodiment, an attachment means including pins, nuts and bolts, or the like may be used to detachably coupled the support rack 120 to the support cart 110. However, the present general inventive concept is not limited thereto.

The support rack 120 may further include wheels 124 to help move and transport the outboard motor support and transport system 100.

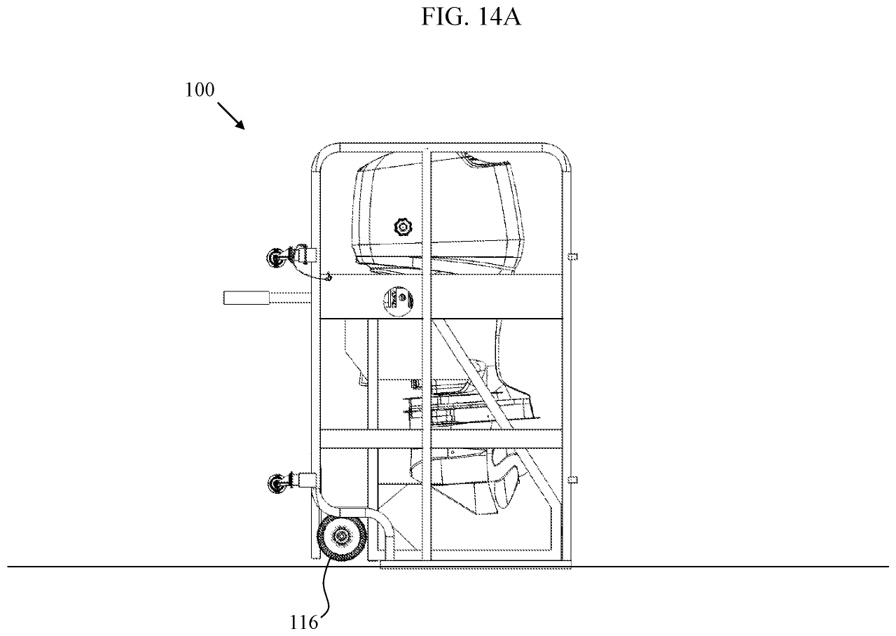

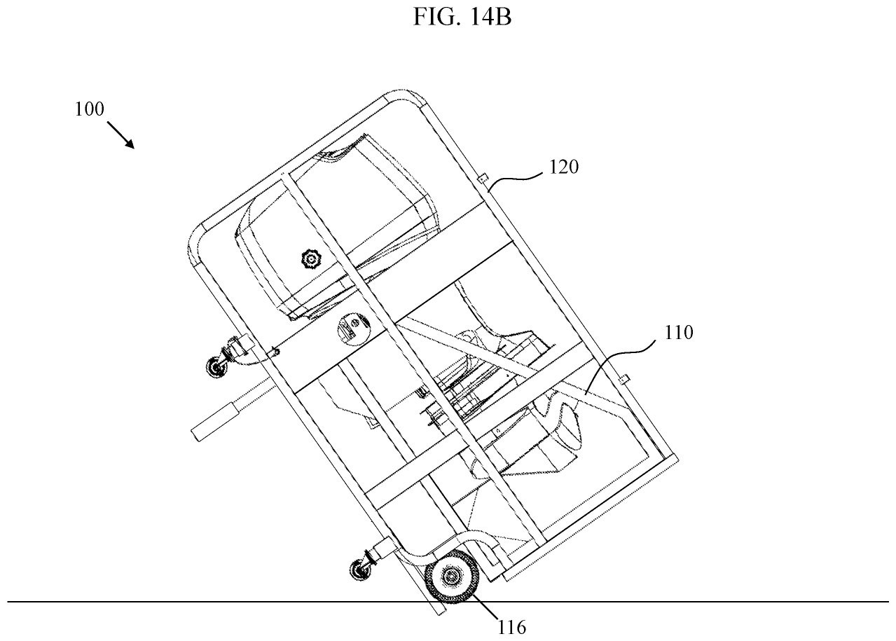

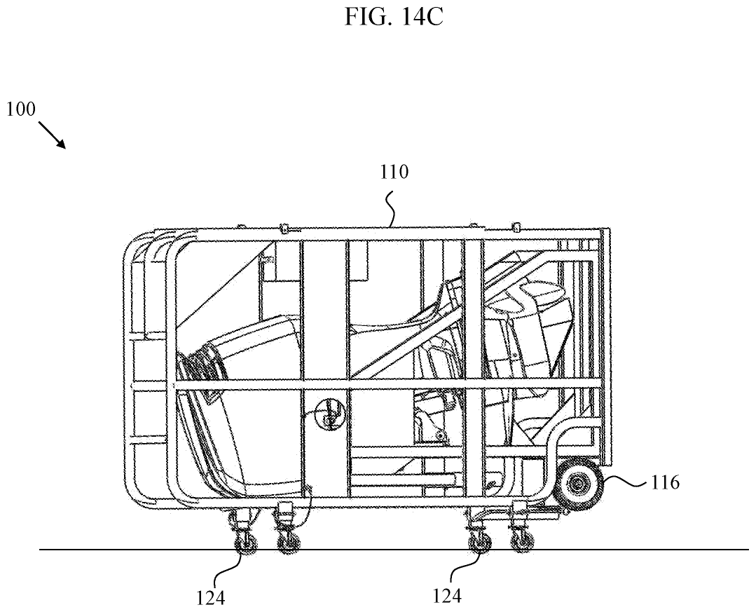

Referring to FIGS. 14B-14C, in the present embodiment, the first pivot member 116 of the support cart 110 may be used to pivot and transport the entire outboard motor support and transport system 100.

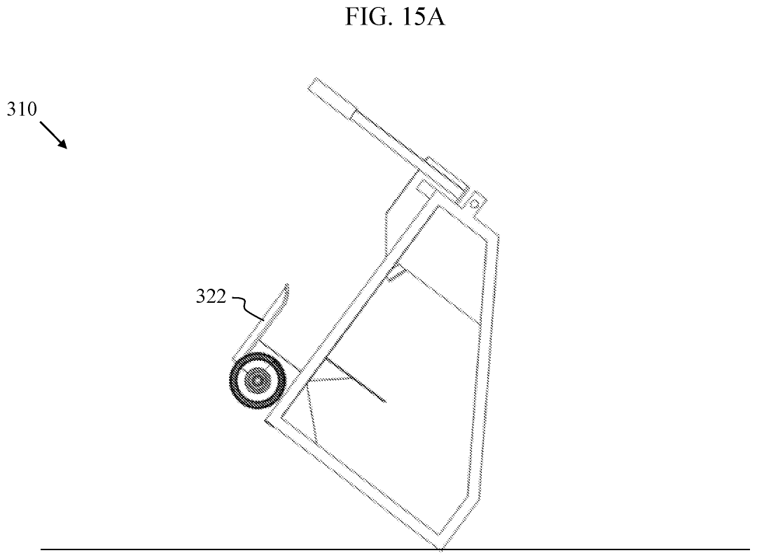

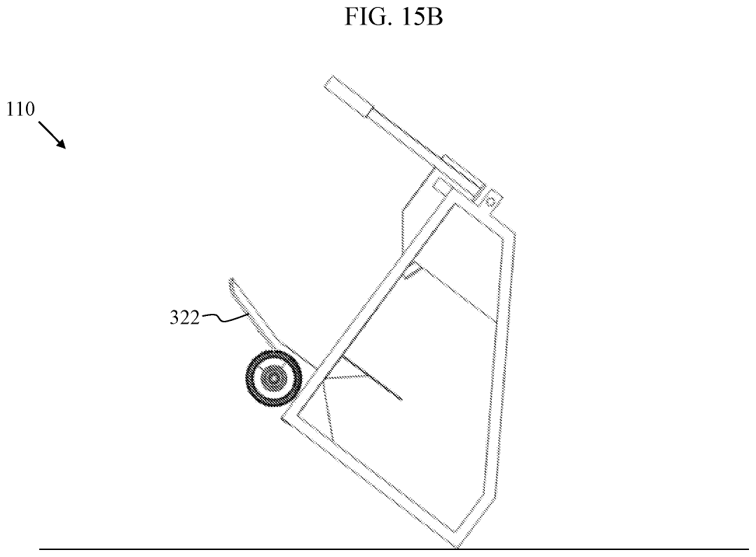

FIGS. 15A-15B are side views of a support cart according to another embodiment of the present general inventive concept.

In the present embodiment, the support cart 210 further includes an extendable foot plate 322 to assist in pivoting the support cart 210 from a first position to a second position, as illustrated in the previous embodiments.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An outboard motor support and transport system, comprising:
a support cart comprising:
a support frame member with a first side substantially perpendicular to a second side and a third side inclined to the first and second side;
a handle member coupled to a first end of the first side of the support frame;
a first pivot member coupled to a second end of the first side of the support frame; and
a second pivot member formed between the second and third sides of the support frame; and
a support rack member having a storage cavity with an opening at a first end,
wherein the first pivot member of the support cart configured to transport the support cart and the support rack member.

2. The outboard motor support and transport system of claim 1, further including a transcom member coupled between the first and third sides of the support frame to detachably support an outboard motor.

3. The outboard motor support and transport system of claim 1, further comprising a pivot support member formed between the second pivot member and the third side of the support frame configured to allow a user to provide weight to support a pivot of the support cart.

4. The outboard motor support and transport system of claim 3, wherein the transcom member is inclined about 14 degrees from the first side of the support frame.

5. The outboard motor support and transport system of claim 1, wherein the handle member extends in a direction perpendicular to the first side of the support frame.

6. A support cart, comprising:
a support frame member having a first side substantially perpendicular to a second side and a third side inclined to the first and second side;
a handle member coupled to a first end of the first side of the support frame;
a first pivot member coupled to a second end of the first side of the support frame; and
a second pivot member formed between the second and third sides of the support frame.

7. The outboard motor support apparatus of claim 6, further comprising a pivot support formed between the second pivot member and the third side of the support frame.

8. The outboard motor support apparatus of claim 1, further a transcom member coupled between the first and third sides of the support frame to detachably support an outboard motor.

9. The outboard motor support apparatus of claim 3, wherein the transcom member is inclined about 14 degrees from the first side of the support frame.

10. The outboard motor support apparatus of claim 1, wherein the handle member extends in a direction perpendicular to the first side of the support frame.
